(19) United States
(12) Patent Application Publication
(10) Pub. No.: US 2026/0139110 A1
(43) Pub. Date: May 21, 2026

(54) METHOD FOR AMINATION OF POLYMER FILM FOR MANUFACTURE OF ANION EXCHANGE MEMBRANE

(71) Applicant: HET HYDROGEN PTE. LTD., ENTERPRISE HUB (SG)

(72) Inventors: Jie Chen, Shanghai (CN); Arthur Ernest Koschany, Shanghai (CN); Hangyu Shao, Shanghai (CN); Zhai Jun, Shanghai (CN)

(21) Appl. No.: 19/033,655

(22) Filed: Jan. 22, 2025

(30) Foreign Application Priority Data
Nov. 18, 2024 (CN) 202411651036.6

(51) Int. Cl. C08J 5/22; B01J 41/05; B01J 41/14; B01J 47/12

(52) U.S. Cl. CPC C08J 5/2287; B01J 41/05; B01J 41/14; B01J 47/12; C08J 5/2243; C08J 2345/00

(57) ABSTRACT

The present technology relates to an improved method for manufacturing anion exchange membranes. The method uses trimethylamine gas for amination of polymer films. The process involves placing polymer film pieces or a roll with thin spacer in a pressure vessel, removing air by applying vacuum, and then filling the vessel with trimethylamine gas at about 1 barg pressure and at about 30° C. temperature. After amination, residual trimethylamine is removed by vacuum and optionally by heat treatment. This gas-based approach eliminates membrane swelling and wrinkling issues associated with aqueous trimethylamine solutions, improves diffusion rates, reduces waste generation, and allows for more efficient and scalable production processes, including the ability to aminate complete rolls of polymer film. The resulting membrane maintains its structural integrity and is more suitable for assembly into electrochemical device stacks.

### CROSS-REFERENCE TO RELATED APPLICATIONS

This application claims the benefit of Chinese Patent Application No. 202411651036.6, filed on Nov. 18, 2024. The entire disclosure of the above application is incorporated herein by reference.

### FIELD

The present technology relates to methods for manufacturing anion exchange membranes, and, more particularly, to processes for aminating polymer films to produce anion exchange membranes for use in electrochemical devices.

### INTRODUCTION

This section provides background information related to the present disclosure which is not necessarily prior art.

Anion exchange membranes (AEMs) have emerged as promising components for various electrochemical devices, including fuel cells, electrolyzers, and chemical separation systems. These membranes offer potential advantages over proton exchange membranes (PEMs) in terms of cost and performance.

Traditionally, the production of AEMs involves a multi-step process, where a prepolymer containing alkyl halide groups is first synthesized and then formed into a membrane. The membrane is subsequently subjected to a quaternization step to convert the alkyl halide groups into quaternary ammonium cations, which are responsible for anion conduction.

One common method for quaternization involves soaking the prepolymer membrane in an aqueous solution of trimethylamine. An example of prior art involving the aqueous solution method is described in International Publication No. WO 2022/026794 A1, titled “POLYCYLOOLEFINIC POLYMERS AND ANION EXCHANGE MEMBRANES DERIVED THEREFROM,” filed on Jul. 30, 2021. This document outlines a process where the membrane is immersed in a 50 wt. % aqueous trimethylamine solution for 48 hours at room temperature to achieve quaternization.

This aqueous solution approach, while effective, presents several significant challenges and disadvantages in the manufacturing process. A key issue with the aqueous trimethylamine solution method is the swelling of the membrane due to water content. This swelling can cause the membrane to release from its backing and develop wrinkles, which is highly unfavorable for assembling the membrane into a stack for use in electrochemical devices.

Another drawback is the slow diffusion rate in liquids, necessitating the use of wide spacers to ensure liquid access to multiple polymer films. This requirement results in the need for large volumes of liquid to aminate a given quantity of membrane pieces. Furthermore, the trimethylamine solution's concentration decreases after use, making it difficult to reuse effectively and leading to significant waste generation.

The aqueous solution method also poses limitations on the amination of complete rolls of polymer film. Even with the use of a porous spacer comparable in thickness to the polymer film, sufficient liquid access cannot be achieved throughout the entire roll.

There is a continuing need for improved methods of manufacturing anion exchange membranes that address the limitations of the aqueous trimethylamine solution approach. Desirably, such methods would eliminate or reduce membrane swelling, improve diffusion rates, minimize waste generation, and allow for more efficient and scalable production processes, including the ability to aminate complete rolls of polymer film.

### SUMMARY

In concordance with the instant disclosure, an improved method of manufacturing anion exchange membranes that addresses the limitations of the aqueous trimethylamine solution approach, and which eliminates or reduces membrane swelling, improves diffusion rates, minimizes waste generation, and allows for more efficient and scalable production processes, including the ability to aminate complete rolls of polymer film, has surprisingly been discovered.

The present technology includes articles of manufacture, systems, and processes that relate to the amination of polymer films using trimethylamine gas to produce anion exchange membranes for electrochemical devices.

In one embodiment, a method for manufacturing an anion exchange membrane includes a step of placing a polymer film in a pressure vessel, followed by a step of removing air from the pressure vessel, for example, by applying a first vacuum to the pressure vessel. The method then includes a step of filling the pressure vessel with trimethylamine gas. Next, the method includes a step of maintaining the trimethylamine gas in the pressure vessel for a first predetermined time sufficient to aminate the polymer film, and to thereby provide an aminated polymer film suitable for use as the anion exchange membrane. The method further includes a step of removing a residual amount of the trimethylamine gas from the pressure vessel, which may be completed, for example, by applying a second vacuum to the pressure vessel. Air is then allowed to enter the pressure vessel in a next step of the method, followed by a step of removing the aminated polymer film from the pressure vessel.

In an exemplary embodiment, the method for manufacturing an anion exchange membrane involves amination using trimethylamine gas. The process begins by placing polymer film pieces or a roll with a thin spacer in a pressure vessel. Air is then removed from the vessel by applying a vacuum. Subsequently, the vessel is filled with trimethylamine gas at a pressure of about 1 barg and a temperature of 30° C. The duration required for amination is comparable to that of liquid amination processes. After the amination is complete, vacuum is applied again to remove residual trimethylamine from the polymer film. Air is then allowed to enter the vessel as the final step. Optionally, an additional trimethylamine removal step can be performed by heat treatment at about 70° C. for one hour.

The resulting membrane exhibits excellent adhesion properties, remaining firmly attached to its backing. Importantly, the membrane is nearly or completely free of wrinkles, which is a significant improvement over traditional liquid-based amination methods. This lack of wrinkling and maintained adhesion to the backing enhances the membrane's suitability for assembly into electrochemical device stacks, potentially leading to improved performance and reliability in various applications.

The method for manufacturing an anion exchange membrane using trimethylamine gas may offer several advantages over traditional liquid-based amination processes. These may include improved uniformity of amination, the ability to process complete rolls of polymer film, reduced waste generation, and potentially enhanced product quality. The resulting anion exchange membranes may also be well-suited for a variety of electrochemical applications, potentially advancing the development of clean energy technologies and chemical separation processes.

In a further embodiment, the membranes of the present disclosure may be useful in a variety of applications including electrochemical devices, and the like. Accordingly, in one aspect of this disclosure there may be provided an electrochemical device comprising the membrane of this disclosure. In another embodiment there may be further provided a fuel cell comprising the membrane of this disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow diagram illustrating a method for manufacturing an anion exchange membrane, according to one embodiment of the present disclosure.

FIG. 2 is a schematic depiction of a synthesis of cross-linked copolymers that are aminated by treatment with gaseous trimethylamine for the forming of the anion exchange membrane, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the manufacturing process for anion exchange membranes by addressing several key limitations of the traditional aqueous trimethylamine solution method. Specifically, it enhances the amination step by utilizing trimethylamine gas instead of an aqueous solution, which eliminates membrane swelling and wrinkling issues, improves diffusion rates, reduces waste generation, and allows for more efficient and scalable production processes, including the ability to aminate complete rolls of polymer film. This gas-based approach enables better control over the amination process, resulting in higher quality membranes that maintain their structural integrity and are more suitable for assembly into electrochemical device stacks.

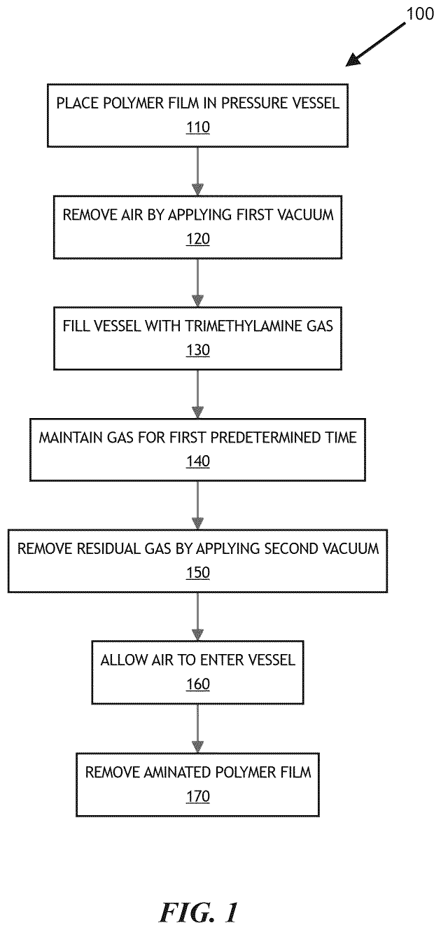

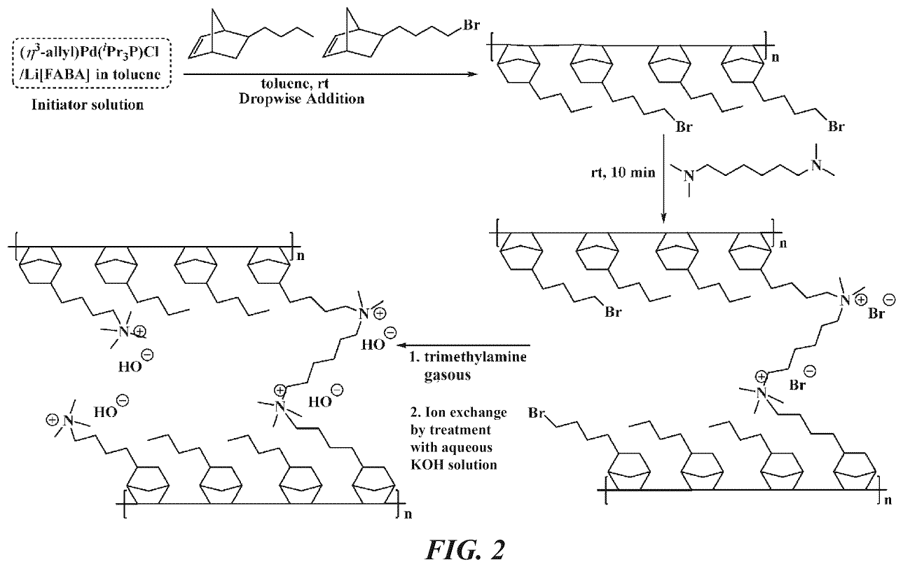

As shown in FIGS. 1 and 2, the present disclosure includes a method 100 for manufacturing an anion exchange membrane. The method 100 may improve upon traditional aqueous-based amination processes by instead utilizing trimethylamine gas to achieve efficient and uniform amination of polymer films.

In one embodiment, the method 100 may begin with a step 110 of placing a polymer film in a pressure vessel. The polymer film may comprise a polycycloolefinic polymer, such as described in International Publication No. WO 2022/026794 A1, titled “POLYCYLOOLEFINIC POLYMERS AND ANION EXCHANGE MEMBRANES DERIVED THEREFROM,” filed on Jul. 30, 2021, as one non-limiting example. The polycycloolefinic polymer film may provide desirable mechanical and chemical properties for the resulting anion exchange membrane. One of ordinary skill in the art may also select other suitable chemistries for the polymer film configured to be employed as the anion exchange membrane subsequent to the amination process of the present disclosure, as desired.

The polymer film may be supplied in the form of pieces or a roll with a thin spacer, for example. As used herein, the term “spacer” is defined as meaning a thin layer or film of porous material. This spacer and related configuration may allow for efficient gas penetration throughout the film structure when used.

Where the thin spacer is employed, it may be placed between each piece or layer. This spacer creates small gaps or channels between the layers of the polymer film, allowing for efficient gas penetration and circulation throughout the entire surface area of the film. By maintaining these spaces between the film layers, the spacer ensures that the trimethylamine gas can uniformly access and react with all parts of the polymer, including areas that might otherwise be in close contact or adhered to each other. This arrangement promotes a more complete and consistent amination process across the entire film, resulting in a uniformly functionalized anion exchange membrane. The use of a spacer may also help militate the film from sticking to itself or becoming wrinkled during the gas-based amination process, as described further herein, and which is a significant improvement over liquid-based methods that often lead to membrane distortion.

The pressure vessel used for the trimethylamine gas amination process may be specially designed to safely handle corrosive and flammable gases. It is capable of maintaining a pressure of about 1 barg (approximately 15 psig) during amination and withstand temperatures around 30° C. (86° F.), with potential for up to 70° C. (158° F.) during optional heat treatment, for example. The vessel may be equipped with vacuum capabilities for air removal and residual gas extraction, as well as a mechanism for controlled air entry post-process. Constructed from corrosion-resistant materials like stainless steel or specialized alloys, the pressure vessel may be rated for the specified pressure and temperature conditions. It may also have appropriate fittings for gas inlet, vacuum connections, and pressure/temperature monitoring devices, complying with relevant safety standards for hazardous gas handling. One skill in the field of the present disclosure may select a suitable type and construction of pressure vessel based on this understanding, as desired.

Following the placement of the polymer film, a step 120 of removing air from the pressure vessel by applying a first vacuum may be performed. It should be appreciated that the moving of the air in the step 120 is just one particular embodiment, and it is contemplated that the pressure vessel could be filled by purging the vessel with the trimethylamine gas without applying any vacuum. This may result in a larger amount of waste gas, and so may be less preferred than the use of the first vacuum, but is expected to otherwise be sufficient. This step 120 may ensure that the subsequent introduction of trimethylamine gas can effectively reach all portions of the polymer film. The removal of air in the method 100 may also militate against any unwanted side reactions or contamination during the amination process.

As a non-limiting example, the pressure vessel may be equipped with a vacuum pump system connected through appropriate valves and fittings. The vacuum pump system allows for the controlled evacuation of air from the vessel. The vacuum application may be performed in stages, with an initial rough vacuum followed by a finer vacuum to ensure thorough air removal. The vacuum level and duration can be optimized based on the vessel size and the amount of polymer film being processed. Additionally, the spacer used between film layers may aid in creating channels that facilitate more efficient air removal throughout the entire film stack or roll via the vacuum. Pressure and vacuum gauges may also be installed on the vessel to monitor the progress of air removal, ensuring that a sufficient vacuum level is achieved before proceeding to the next step of introducing the trimethylamine gas. This careful air removal process may advantageously create an environment where the trimethylamine gas can effectively and uniformly interact with the polymer film, promoting consistent amination across the entire membrane surface.

After the air removal, a step 130 of filling the pressure vessel with trimethylamine gas may be carried out. It should be appreciated that trimethylamine gas has a relatively low vapor pressure, and at 30 the pressure is only 2.5 barg, and at 40° C. the pressure is only about 3.5 barg. High pressures of the trimethylamine gas can be reached only at high temperatures. In the present embodiment, the trimethylamine gas may be introduced at a first predetermined pressure of about 1 barg, although the first predetermined pressure may range from ambient pressure to about 20 barg depending on the specific requirements of the process. This pressure range may be selected to allow for optimal gas penetration and reaction with the polymer film.

Non-limiting examples of the first predetermined pressure for introducing trimethylamine gas into the pressure vessel include about 1 barg, about 2 barg, or about 5 barg. The specific pressure may be adjusted based on factors such as the thickness of the polymer film, the desired rate of amination, or the capacity of the pressure vessel. For instance, a higher pressure may be used for thicker films or when a faster amination process is desired, while a lower pressure might be suitable for thinner films or when a more gradual amination is preferred. Additionally, the pressure may be varied during the process, starting at a lower pressure and gradually increasing to ensure uniform gas penetration throughout the film layers. One of ordinary skill in the art may also select intermediate pressures or pressure ranges within the specified range as desired, based on the specific requirements of the polymer film and the intended application of the resulting anion exchange membrane.

In a step 140, the trimethylamine gas may be maintained in the pressure vessel for a first predetermined time sufficient to aminate the polymer film. This duration may be comparable to the time required for liquid amination processes, for example. For example, the first predetermined time may be between about 1 hour and about 72 hours, and more particularly may be about 24 hours. Without being bound to any particular theory, however, it is believed that the use of gas may allow for more uniform and efficient amination compared to liquid-based methods, potentially reducing overall processing time.

Non-limiting examples of the first predetermined time for maintaining the trimethylamine gas in the pressure vessel include about 12 hours, about 18 hours, or about 36 hours. The specific duration may be adjusted based on factors such as the thickness of the polymer film, the desired degree of amination, or the reactivity of the particular polymer being processed. For instance, a longer duration may be used for thicker films or when a higher degree of amination is desired, while a shorter duration might be suitable for thinner films or when a lower degree of amination is sufficient. Additionally, the amination time may be optimized in conjunction with other process parameters such as temperature and pressure to achieve the desired balance between amination efficiency and processing time. One of ordinary skill in the art may also select intermediate durations or time ranges within the specified range as desired, based on the specific requirements of the polymer film and the intended properties of the resulting anion exchange membrane.

The step 140 may further include a maintaining of a first predetermined temperature during the amination process, for example, at about 30° C. However, it should be appreciated that the first predetermined temperature may be varied within a range of about 20° C. to about 80° C. to optimize the reaction kinetics and efficiency.

Non-limiting examples of the first predetermined temperature for maintaining the trimethylamine gas in the pressure vessel include about 25° C., about 40° C., or about 60° C. The specific temperature may be adjusted based on factors such as the composition of the polymer film, the desired rate of amination, or the stability of the polymer at elevated temperatures. For instance, a higher temperature may be used to accelerate the amination process or when working with more thermally stable polymers, while a lower temperature might be suitable for more temperature-sensitive materials or when a more gradual amination is preferred. Additionally, the temperature may be varied during the process, starting at a lower temperature and gradually increasing to optimize the reaction kinetics and ensure uniform amination throughout the film layers. A skilled artisan may also select intermediate temperatures or temperature ranges within the specified range as desired, based on the specific requirements of the polymer film and the intended properties of the resulting anion exchange membrane.

The ability to control at least one of the pressure and the temperature precisely is also considered a further advantage of the gas-based method over traditional liquid-based approaches. One skilled in the art may also predetermine and select any other suitable pressure and temperature for the trimethylamine gas within the pressure vessel, consistent with the scope of the present disclosure.

After the amination is complete, a step 150 of applying a second vacuum to the pressure vessel may be performed to remove residual trimethylamine from the polymer film. This step may be helpful for ensuring that an excess or residual amount of the trimethylamine gas is effectively removed, preventing over-amination or unwanted side reactions or interactions with catalysts or electrolytes in the final application. The vacuum may be maintained for a second predetermined time sufficient to substantially remove all of the residual amount of the trimethylamine gas from the polymer film, and likewise from the pressure vessel.

Non-limiting examples of the second predetermined time for applying vacuum to remove residual trimethylamine gas include about 30 minutes, about 1 hour, or about 2 hours. The specific duration may be adjusted based on factors such as the volume of the pressure vessel, the amount of polymer film being processed, or the desired level of residual gas removal. For instance, a longer vacuum application time may be used for larger pressure vessels or when processing a greater quantity of polymer film, while a shorter duration might be sufficient for smaller batches or when a lower level of residual gas removal is acceptable. Additionally, the vacuum removal process may be enhanced by heating the pressure vessel to a second predetermined temperature, typically between about 50° C. and about 90° C., for example about 70° C., which can facilitate the desorption of trimethylamine from the polymer film. One of ordinary skill in the art may also select intermediate durations or time ranges within the specified range as desired, based on the specific requirements of the polymer film and the intended properties of the resulting anion exchange membrane.

Alternatively, it should be appreciated that the pressure vessel may be purged with air instead of using the second vacuum, and thereby remove the trimethylamine gas by purge. The grade of removal of residual trimethylamine gas which was dissolved in the membrane may be lower in such cases, but with some optional trimethylamine gas heat treatment, the purge method is also deemed sufficient and would be operable for the intended purpose.

If there is still too much trimethylamine gas dissolved in the polymer film, another step of heating the polymer film in air in a well-ventilated oven between about 60° C. and about 90° C. may be performed. In case of a roll of the polymer film, the roll may first be unrolled in a long heating section of the oven. It should be appreciated that heating the roll or sheet material under vacuum is difficult because heat transfer in vacuum is poor, and so heating of the polymer film in air may be preferred in certain embodiments.

Following the vacuum step, a step 160 of allowing air to enter the pressure vessel may be carried out. This step serves multiple important purposes in the amination process. It helps normalize the pressure within the vessel, preparing the aminated polymer film for removal in accordance with step 170. The controlled reintroduction of air equalizes the pressure inside the vessel with the atmospheric pressure outside, which is crucial for safely opening the vessel and removing the aminated polymer film.

Additionally, this pressure normalization may minimize any pressure differentials that could potentially damage or distort the film during extraction. The controlled reintroduction of air also assists in the final stages of residual trimethylamine removal. As fresh air enters the vessel, it can help displace and dilute any remaining traces of trimethylamine gas, further ensuring the thorough removal of the reactive gas.

It should also be appreciated that the step 160 may serve as a safety measure, mitigating potential risks associated with opening a vessel that has been under vacuum or contained reactive gases. Furthermore, it acts as a quality control measure, ensuring that the aminated polymer film is exposed to standard atmospheric conditions before further processing or testing, which can be important for consistency in the final product properties.

In some embodiments, an optional step (not shown) of performing an additional trimethylamine removal step by heat treatment, e.g., in a well-ventilated oven, may be included. This heat treatment may be conducted at the second predetermined temperature of between about 50° C. and about 90° C., and more particularly about 70° C. This heat treatment may also be conducted at a second predetermined time, for example, between about 30 minutes and about 2 hours, and more particularly for approximately 1 hour. The heat treatment may further ensure complete removal of any remaining trimethylamine and may also assist in stabilizing the newly formed quaternary ammonium groups within the polymer structure. Other suitable second predetermined temperatures and second predetermined times may also be employed within the scope of the present disclosure, as desired.

As described hereinabove, the polymer film used in the method 100 may comprise a polycycloolefinic polymer with repeating units derived from norbornene-type monomers. At least one of these norbornene-type monomers may comprise a pendent alkyl halide group, which may serve as the reaction site for the amination process. In many cases, the pendent alkyl halide group may be a bromoalkyl group, which may offer a good balance of reactivity and stability. However, it is also contemplated that other types of pendent alkyl halide groups such as alkyl iodide groups, alkyl chloride group, and alkyl fluoride groups may also be employed.

In certain embodiments, the polymer film may also be supplied as a prepolymer film formed by solvent casting prior to the amination process. This prepolymer approach may allow for easier handling and processing of the film before the introduction of ionic groups. The ability to work with a prepolymer may be particularly advantageous for large-scale manufacturing processes. In such a case, the method 100 of the present disclosure may further include a step of crosslinking the prepolymer film following the amination. Crosslinking may enhance the mechanical stability and control the swelling behavior of the resulting anion exchange membrane. The crosslinking step may be performed using various techniques, such as thermal treatment or the addition of specific crosslinking agents.

In some embodiments, the polymer film may be supplied in the form of a roll with a spacer. The gas-based amination method 100 may be particularly well-suited for processing rolls of polymer film, as it may allow for more uniform gas penetration compared to liquid-based methods. This capability may significantly enhance the scalability and efficiency of the manufacturing process.

It should be appreciated that the resulting anion exchange membrane produced by the method 100 may have an ion exchange capacity or IEC of at least 3 meq/g. In particular, the anion exchange membrane may have an ion exchange capacity of between about 3 meq/g and about 5 meq/g. This high ion exchange capacity may indicate a substantial degree of amination and may contribute to the membrane's effectiveness in various electrochemical applications. The ion exchange capacity may be measured using standard titration techniques known in the art.

The method 100 may produce the aminated polymer film with unique properties due to the gas-based amination process. This polymer may exhibit improved uniformity of amination and potentially better mechanical properties compared to polymers aminated using traditional liquid-based methods. The gas-based approach may allow for better control over the degree of amination and may result in a more consistent product.

The anion exchange membrane having the polymer formed according to the method 100 may also be suitable for use in various electrochemical devices. These may include fuel cells, electrolyzers, and chemical separation systems. The membrane may offer advantages such as high conductivity, good mechanical stability, and resistance to chemical degradation in alkaline environments.

The method 100 may also be particularly advantageous for large-scale production of anion exchange membranes. The ability to process complete rolls of polymer film and the potential for more uniform amination may contribute to improved manufacturing efficiency and product consistency. These factors may be helpful for the commercial viability of anion exchange membrane-based technologies.

It should be appreciated that the gas-based amination approach of method 100 may further offer environmental benefits compared to liquid-based methods. The use of gaseous trimethylamine may reduce waste generation and minimize the need for large volumes of liquid reagents. This may result in a more sustainable manufacturing process with reduced environmental impact.

Advantageously, the anion exchange membrane manufactured according to the method 100 of the present disclosure may also offer improved performance characteristics due to the gas-based amination process. In particular, this membrane may exhibit enhanced uniformity in its ionic properties and potentially better mechanical stability compared to membranes produced using traditional liquid-based amination methods.

Furthermore, the anion exchange membrane made according to the method 100 may be given a backing to which it is selectively adhered prior to the installation, for example, during shipping and storage in the form of a complete roll. This backing may provide additional structural support and ease of handling for the membrane. The use of the backing may be particularly beneficial for maintaining the integrity of the anion exchange membrane during manufacturing and subsequent assembly into electrochemical devices. This configuration may also be advantageous for large-scale production and handling of the anion exchange membrane.

Importantly, the anion exchange membrane manufactured according to the method 100 may remain adhered to the backing while in the complete roll and may be substantially free of wrinkles. This characteristic is a notable improvement over traditional liquid-based amination methods, which often result in membrane swelling, detachment from the backing, and wrinkling. The absence of wrinkles and maintained adhesion to the backing may greatly improve the suitability of the membrane of the present disclosure for assembly into stacks for various electrochemical applications, potentially leading to enhanced performance and reliability of the final devices.

### EXAMPLES

Example embodiments of the present technology are provided with reference to the figures enclosed herewith.

### Example 1: Gas-Based Amination of Polymer Film

With reference to FIG. 1, a polymer film comprising a polycycloolefinic polymer with repeating units derived from norbornene-type monomers, including 5-(4-bromobutyl)bicyclo[2.2.1]hept-2-ene, may be prepared by solvent casting. The film may have a thickness of approximately 30 μm and may be cut into pieces of 10 cm×10 cm.

The polymer film pieces may be placed in a pressure vessel with a thin spacer between each piece to allow for gas penetration. The pressure vessel may be sealed, and a vacuum may be applied to remove air from the vessel. The vacuum may be maintained for 30 minutes to ensure complete air removal.

After the air removal step, the pressure vessel may be filled with trimethylamine gas. The pressure within the vessel may be increased to 1 barg, and the temperature may be maintained at 30° C. These conditions may be maintained for 48 hours to allow for complete amination of the polymer film.

Following the amination period, a vacuum may be applied to the pressure vessel to remove residual trimethylamine gas. This vacuum step may be maintained for 1 hour to ensure thorough removal of excess trimethylamine. Subsequently, air may be allowed to enter the vessel, returning it to atmospheric pressure.

As an additional step to ensure complete removal of residual trimethylamine, the aminated polymer film may be subjected to a heat treatment at 70° C. for one hour in a separate oven, which is well-ventilated. After this treatment, the film may be allowed to cool to room temperature.

The resulting aminated polymer film may have an ion exchange capacity (IEC) of about 3.0 to 5.0 meq/g, as determined by titration. The film may exhibit excellent mechanical properties and may be expected to remain adhered to its backing without any visible wrinkles or distortions. When tested for hydroxide conductivity, the membrane may be expected to have a value of about 180 mS/cm at 80° C.

To evaluate the stability of the membrane, samples may be immersed in 1 M NaOH solution at 80° C. for 1000 hours. After this extended alkaline exposure, the membrane may be expected to retain over 95% of its initial ion exchange capacity and show no significant degradation in mechanical properties.

The aminated polymer film may be expected to be successfully incorporated into a fuel cell assembly as an anion exchange membrane. The fuel cell may demonstrate stable performance over 500 hours of operation, with minimal voltage degradation, showcasing the membrane's suitability for electrochemical applications.

### Example 2: Substitution of Aqueous-Based Amination With Gas-Based Amination of Polymer Film

As shown in FIG. 2, preparation of a bi-functional crosslinked polymer for use according to the present disclosure may begin by using tetramethylhexamethylenediamine or TMHDA. First, the polymer of this example may be formed into a suitable three-dimensional object such as in a form of a tubular composite, hollow fiber, a dense film flat sheet, or a thin film composite, which are commonly used as membrane materials. In particular, an e-PTFE reinforced film may be produced from the cross linked polymer by solution casting or another suitable methodology.

In accordance with the schematic illustration in FIG. 2, a precursor polymer in the form of a film where bromine may be reacted with a multifunctional amine such as, for example, TMHDA, to form a crosslinked polymer having such desirable amount of crosslinking depending upon the intended end use. Such crosslinking reaction may generally be carried out at ambient room temperature conditions in a suitable solvent. Other suitable bases may also be employed.

After completion of the crosslinking reaction the polymer may be treated further with gaseous trimethylamine, as detailed hereinabove, to completely replace all of bromine with the amino group. Various other suitable amines may also be employed.

With respect to FIG. 2, after the treatment with the gaseous trimethylamine the functional groups still contain Br— as counter ions. As a last step to finish the membrane these Br— ions will be exchanged to OH— ions by treatment with an aqueous KOH or NaOH solution, as also shown in FIG. 2, as non-limiting examples. This alkaline treatment can be done and may be preferred to be done after the electrolysis stack is completely assembled.

The membranes made in accordance with this example may be capable of IEC of at least 3 meq/g and generally it may range from about 3 meq/g to 5 meq/g or higher. In some embodiments the membranes made in accordance with this example may be capable of IEC of up to 4 meq/g or higher. In addition, the membranes made in accordance with this example may exhibit very high hydroxide conductivity of more than 200 mS/cm at 80° C. In some embodiments the membranes made in accordance with this example may exhibit hydroxide conductivity in the range of from about 100 mS/cm to about 190 mS/cm at 80° C. Accordingly, in some embodiments the membranes of this example may be capable of IEC of at least 3 meq/g for at least 800 hours at a temperature from about 20° C. to about 100° C. in an aqueous alkaline medium.

Another advantageous property of the membranes of this example is that they may exhibit very high chemical stability especially in an alkaline medium. Accordingly, in some embodiments the membranes of this example may be stable for at least 800 hours at a temperature from about 20° C. to about 100° C. in an aqueous alkaline medium. In some other embodiments the membranes of this example may be stable for 1000 hours at a temperature of about 80° C. in an aqueous alkaline medium.

### Example 3: Gas-Amination of Membrane-Catalyst Layer Composite

The gas-amination process of the present disclosure can be advantageously applied to composites containing both the anion exchange membrane and a catalyst layer. In this configuration, the catalyst layer contains a small amount of the same polymer as the membrane, which also requires amination. The pressure vessel is loaded with the composite material, consisting of the polymer film and the attached catalyst layer.

The gas-amination process proceeds as described earlier, with the trimethylamine gas penetrating both the membrane and the catalyst layer simultaneously. This uniform gas exposure ensures consistent amination throughout the composite structure. The gaseous trimethylamine can more easily penetrate the porous catalyst layer, ensuring uniform amination of the polymer within it. This is particularly beneficial for maintaining the integrity of the catalyst layer-membrane interface, as gas-amination minimizes swelling and potential distortion of the composite structure compared to liquid amination methods.

The advantages of gas-amination for such composites include improved efficiency, as it eliminates the need for separate amination steps for the membrane and catalyst layer, potentially reducing overall processing time. Additionally, the gas-based method allows for better control of the amination process parameters, potentially leading to more consistent and reproducible results in the final composite structure. This approach demonstrates the versatility of the gas-amination method for more complex electrode-membrane assemblies, highlighting its potential for producing high-quality anion exchange membranes with integrated catalyst layers for various electrochemical applications.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for manufacturing an anion exchange membrane, comprising:
providing a polymer film;
placing the polymer film in a pressure vessel;
filling the pressure vessel with trimethylamine gas;
maintaining the trimethylamine gas in the pressure vessel for a first predetermined time sufficient to aminate the polymer film to provide an aminated polymer film suitable for use as the anion exchange membrane;
allowing air to enter the pressure vessel; and
removing the aminated polymer film from the pressure vessel.

2. The method of claim 1, wherein the first predetermined time is between about 1 hour and about 48 hours.

3. The method of claim 2, wherein the first predetermined time is about 24 hours.

4. The method of claim 1, further comprising a step of maintaining the trimethylamine gas in the pressure vessel at a first predetermined pressure between ambient pressure and about 20 barg.

5. The method of claim 4, wherein the first predetermined pressure is about 1 barg.

6. The method of claim 1, further comprising a step of maintaining the trimethylamine gas in the pressure vessel at a first predetermined temperature between about 20° C. and about 80° C.

7. The method of claim 6, wherein the first predetermined temperature is about 30° C.

8. The method of claim 1, further comprising steps of:
following the placing of the polymer film in the pressure vessel, removing air from the pressure vessel by applying a first vacuum to the pressure vessel; and
following the maintaining of the trimethylamine gas in the pressure vessel for the first predetermined time, removing a residual amount of the trimethylamine gas from the pressure vessel by applying a second vacuum to the pressure vessel, and wherein the second vacuum applied to remove the residual amount of the trimethylamine gas is maintained for a second predetermined time sufficient to substantially remove all of the residual amount of the trimethylamine gas from the aminated polymer film.

9. The method of claim 1, wherein the step of removing the residual amount of the trimethylamine gas further includes a step of heating the aminated polymer film in the pressure vessel to a second predetermined temperature for a second predetermined time.

10. The method of claim 9, wherein the second predetermined temperature is between about 50° C. and about 90° C.

11. The method of claim 10, wherein the second predetermined temperature is about 70° C.

12. The method of claim 9, wherein the second predetermined time is between about 30 minutes and 2 hours.

13. The method of claim 12, wherein the second predetermined time is about 1 hour.

14. The method of claim 1, wherein the polymer film comprises a polycycloolefinic polymer.

15. The method of claim 14, wherein the polycycloolefinic polymer has repeating units derived from norbornene-type monomers.

16. The method of claim 1, wherein the polymer film is a prepolymer film formed by solvent casting.

17. The method of claim 1, wherein the polymer film is provided in a form of pieces or a roll with a thin spacer.

18. The method of claim 1, wherein the anion exchange membrane formed from the aminated polymer film has an ion exchange capacity of at least about 3 meq/g.

19. The method of claim 18, wherein the ion exchange capacity of is between about 3 meq/g and about 5 meq/g.

20. The anion exchange membrane comprising the aminated polymer film formed according to the method of claim 1.
